(19) United States
(12) Patent Application Publication
(10) Pub. No.: US 2021/0123656 A1
(43) Pub. Date: Apr. 29, 2021

(54) TWO-SHOT BLOW MOLDED COOLER

(71) Applicant: Igloo Products Corp., Katy, TX (US)

(72) Inventors: Dahu Li, Guangzhou City (CN); John Maldonado, Katy, TX (US); Vasanthi Iyer, Wilmington, DE (US); Roque Barros, Katy, TX (US)

(21) Appl. No.: 17/071,370

(22) Filed: Oct. 15, 2020

Related U.S. Application Data
(60) Provisional application No. 62/927,532, filed on Oct. 29, 2019.

(51) Int. Cl. F25D 23/02; F25D 3/08; F25D 23/06; F25D 23/08; B29C 49/22

(52) U.S. Cl. CPC F25D 23/028; F25D 3/08; F25D 23/066; B29L 2031/7162; B29C 49/22; F25D 2201/122; B29K 2995/0021; F25D 23/08

(57) ABSTRACT

A cooler with a two-color lid includes a cooler body and a lid designed to cover a cavity of the cooler body. The lid includes an outer section and an inner section. The lid is a blow-molded lid, where a color of the outer section is different from a color of the inner section.

### RELATED APPLICATIONS

The present application claims priority under 35 U.S.C. § 119 to U.S. Provisional Application No. 62/927,532, entitled “Two-Shot Blow Molded Cooler”, filed on Oct. 29, 2019, the entirety of which is incorporated by reference herein.

### TECHNICAL FIELD

The present disclosure relates generally to coolers, and more particularly, to a cooler having a lid that has different inner and out surface colors.

### BACKGROUND

Coolers, ice chests, ice boxes, or the like are commonly used to store contents (e.g., food, beverages, etc.) and keep the contents cool. For example, coolers are often made from plastic. A cooler typically has a lid a container part and a lid that covers the cavity of the container part. A single piece lid is typically made in one color that may match the color of the inside surface and/or the outside surface of the container part. For example, a single piece cooler lid is typically made from a material (e.g., plastic) that has a single color. The color of the material may be selected to match the inside surface and/or the outside surface of the container part or may be different from both the inside and outside surfaces. However, in some cases, it may be desirable for a cooler lid to have multiple colors. Thus, a solution that provides a cooler that has a lid with multiple colors may be desirable.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 shows a front view of a cooler with a two-color blow molded lid according to an embodiment;

FIG. 2 shows a front perspective view of the cooler of FIG. 1 according to an embodiment;

FIG. 3 shows a front view of a cooler with a two-color blow molded lid according to an embodiment;

FIG. 4 shows a front view of a cooler with a two-color blow molded lid according to an embodiment; and

FIG. 5 shows a simplified system for producing the lids of the coolers of FIGS. 1-4 according to an embodiment.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Referring now to embodiments of the present disclosure, the biodegradable cooler discussed herein can be made of a biodegradable material, such as a pulp-based material, or made from paper, sugar cane, hemp, bamboo, or the like. Because the pulp-based material, or other similar type material, is compostable, recyclable, and/or biodegradable, the cooler can be disposed in an environmentally friendly manner in which the cooler degrades rapidly relative to conventional polystyrene coolers and without toxic residues.

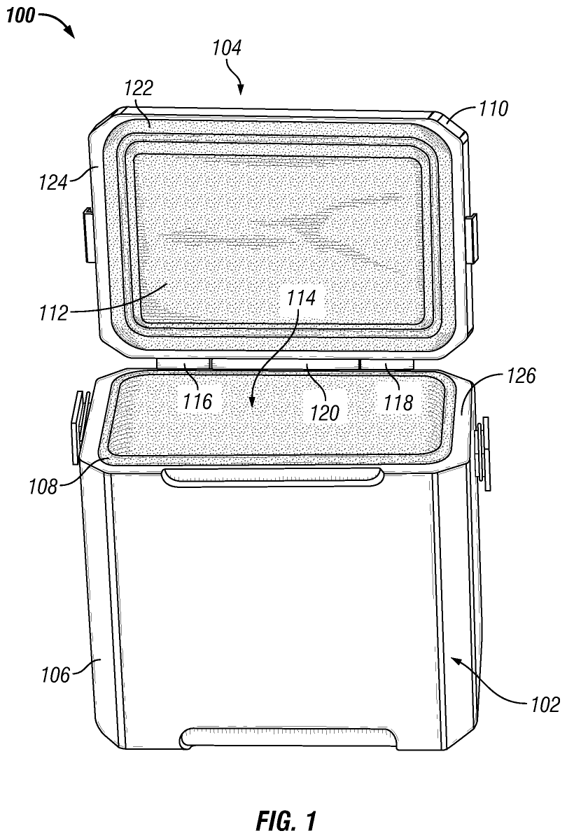

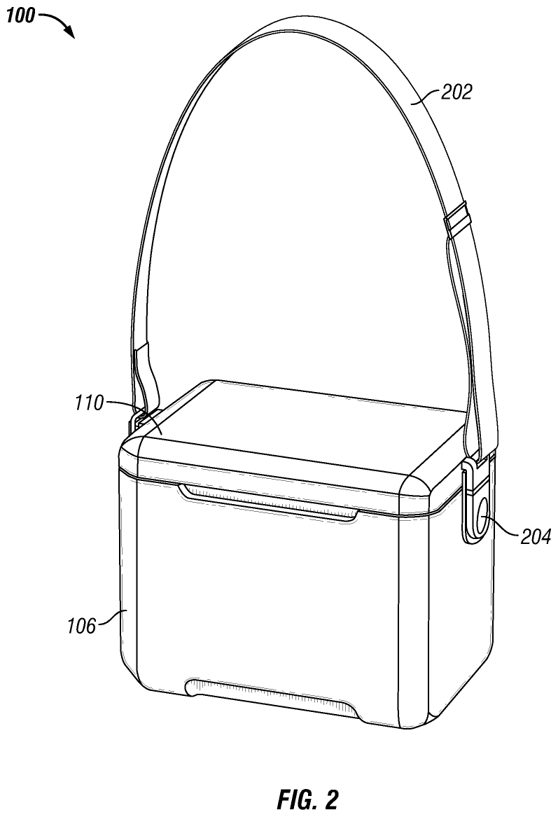

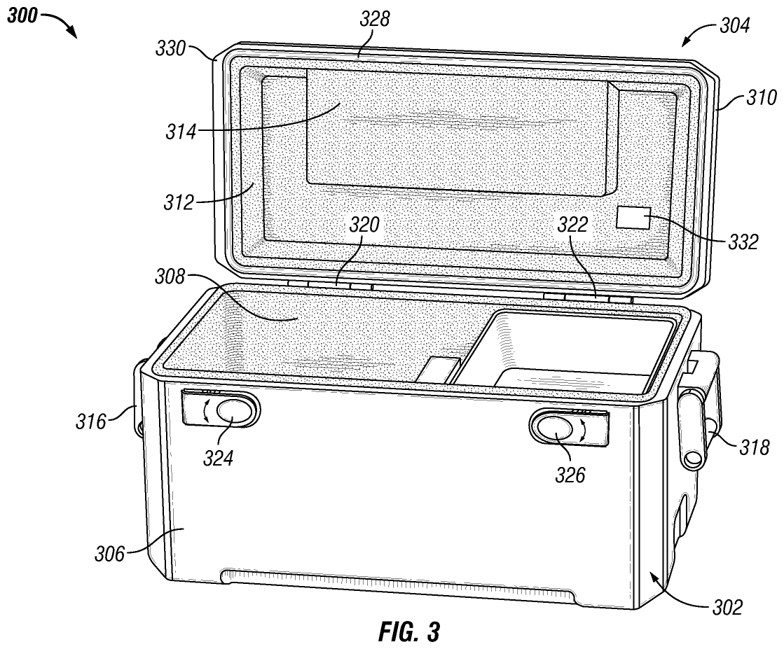

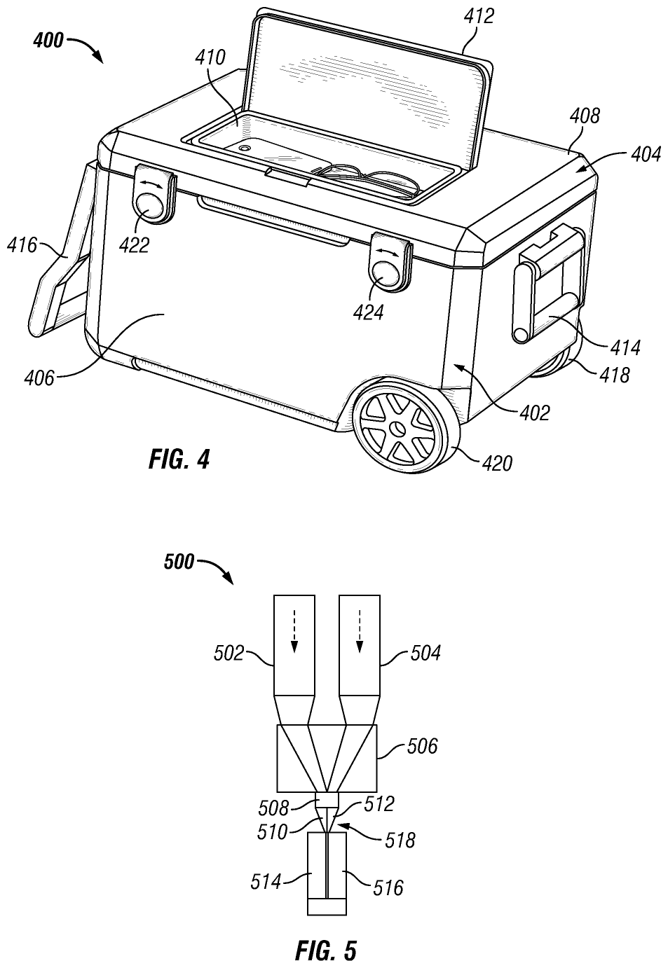

The accompanying figures illustrate various embodiments of the disclosed biodegradable cooler. As described in detail hereinbelow, FIG. 1 shows a front view of a cooler with a two-color (i.e., two-shot) blow molded lid according to an embodiment; FIG. 2 shows a front perspective view of the cooler of FIG. 1 according to an embodiment; FIG. 3 shows a front view of a cooler with a two-color blow molded lid according to an embodiment; FIG. 4 shows a front view of a cooler with a two-color blow molded lid according to an embodiment; and FIG. 5 shows a simplified system for producing the two-color lid for the coolers of FIGS. 1-4 according to an embodiment.

It is understood that the aforementioned embodiments and features associated therewith are not mutually exclusive of each other. Any of the features shown to be associated with an embodiment described herein may be adopted in another embodiment described herein. Therefore, the description herein of various embodiments does not imply that any features associated with a particular embodiment are limited solely to said embodiment.

FIG. 1 shows a front view of a cooler 100 with a two-color blow molded lid according to an embodiment, and FIG. 2 shows front perspective view of the cooler 100 of FIG. 1 according to an embodiment. Referring to FIGS. 1 and 2, in some example embodiments, the cooler 100 includes a cooler body 102 and a lid 104 that is designed to cover a cavity of the cooler body 102. The cooler body 102 may include an outer shell 106 and a liner 108 that is positioned in the outer shell 106. A person may use the cooler 100 by placing items in a cavity 114 of the cooler body 102.

In some example embodiments, the outer shell 106 may be made from plastic and/or another material using a method such as blow molding. That is, the outer shell 106 may be a blow-molded shell. The liner 108 may also be made from plastic and/or another material using a method such as injection molding. That is, the liner 108 may be an injection-molded liner. In some example embodiments, the liner 108 may be removable from the outer shell 106. In some example embodiments, the liner 108 may be a hard-sided liner. In some alternative embodiments, the liner 108 may be a soft-sided liner.

In some example embodiments, the outer shell 106 and the liner 108 may be different colors from each other. For example, the outer shell 106 may be red, and the liner 108 may be blue. As another example, the outer shell 106 may be orange, and the liner 108 may be aqua. As yet another example, the outer shell 106 may be green, and the liner 108 may be blue. As yet another example, the outer shell 106 may be gray, and the liner 108 may be purple. In general, the outer shell 106 may have one of several colors that is different from the color of the liner 108.

In some example embodiments, the lid 104 is a single-piece lid that includes an outer section 110 and an inner section 112. The inner section 112 may be visible when the lid 104 is open as shown in FIG. 1 and may be hidden from view when the lid 104 is closed as shown in FIG. 2. In general, the outer section 110 of the lid 104 is visible on the outside of the cooler 110 regardless of whether the lid 104 is open or closed.

In some example embodiments, the lid 104 may be foamed. To illustrate, the inner space between the outer section 110 and the inner section 112 may be partially or fully filled with foam (e.g., polyurethane foam). Alternatively, the lid 104 may be a non-foamed lid.

In some example embodiments, the lid 104 may be made from plastic and/or another material using a two-shot blow molding method. For example, a double-extrusion blow molding method may be used to extrude a plastic material that is partly in one color (e.g., black) and partly in another color (e.g., gray), where the two-color extruded plastic material is blow molded into the shape of the lid 104. To illustrate, the part of the extruded plastic material that has one color is blow molded into the outer section 110, and the part of the extruded plastic material that has the second color is blow molded into the inner section 112.

In some example embodiments, the lid 104 may be rotatably attached to the cooler body 102 by attachment structures 116, 118, 120. For example, the lid 104 may be rotatably attached to the outer shell 106. To illustrate, the lid 104 may include the attachment structure 120 that is snap-fit between attachment structures 116 and 118 of the outer shell 106. In some alternative embodiments, the lid 104 may be rotatably attached to the cooler body 102 by outer means without departing from the scope of this disclosure. In some alternative embodiments, the lid 104 may not be rotatably attached to the cooler body 102. For example, the lid 104 may be a removable lid that is pressed down onto the cooler body to close the cooler 100.

In some example embodiments, the inner section 112 may include an insert portion 122 and a lip portion 124. For example, when the lid 104 is closed as shown in FIG. 2, the insert portion 122 may extend into the cavity 114 of the cooler body 102 and the lip portion 122 may at least partially rest on a top surface 126 of the outer shell 106 of the cooler body 102. In some example embodiments, the inert portion 122 may come contact the liner 108 and serve to retain the lid 104 in place.

In some example embodiments, the outer section 110 of the lid 104 may have a different color from the inner section 112 of the lid. For example, the outer section 110 may be red, and the inner section 112 may be blue. As another example, the outer section 110 may be orange, and the inner section 112 may be aqua. As yet another example, the outer section 110 may be green, and the inner section 112 may be blue. As yet another example, the outer section 110 may be gray, and the inner section 112 may be purple. In general, the outer section 110 may have one of several colors that is different from the color of the inner section 112.

In some example embodiments, the outer shell 106 of the cooler body 102 may have the same or substantially the same color as the outer section 110 of the lid 104. For example, the outer shell 106 of the cooler body 102 and the outer section 110 of the lid 104 may be red in color. As another example, the outer shell 106 of the cooler body 102 and the outer section 110 of the lid 104 may be orange in color. As yet another example, the outer shell 106 of the cooler body 102 and the outer section 110 of the lid 104 may be blue in color. As yet another example, the outer shell 106 of the cooler body 102 and the outer section 110 of the lid 104 may be gray in color. In general, the outer shell 106 of the cooler body 102 and the outer section 110 of the lid 104 may have one of several colors. In some alternative embodiments, the outer shell 106 of the cooler body 102 and the outer section 110 of the lid 104 may have different colors from each other.

In some example embodiments, the liner 108 of the cooler body 102 may have the same or substantially the same color as the inner section 112 of the lid 104. For example, the liner 108 of the cooler body 102 and the inner section 112 of the lid 104 may be red in color. As another example, the liner 108 of the cooler body 102 and the inner section 112 of the lid 104 may be orange in color. As yet another example, the liner 108 of the cooler body 102 and the inner section 112 of the lid 104 may be blue in color. As yet another example, the liner 108 of the cooler body 102 and the inner section 112 of the lid 104 may be gray in color. In general, the liner 108 of the cooler body 102 and the inner section 112 of the lid 104 may have one of several colors. In some alternative embodiments, the liner 108 of the cooler body 102 and the inner section 112 of the lid 104 may have different colors from each other.

In some example embodiments, the outer shell 106 of the cooler body 102 may have the same or substantially the same color as the outer section 110 of the lid 104, and the liner 108 of the cooler body 102 may have the same or substantially the same color as the inner section 112 of the lid 104 but different from the color of the outer shell 106 and the outer section 110. In some alternative embodiments, the outer shell 106 of the cooler body 102 may have the same or substantially the same color as the outer section 110 of the lid 104, and the liner 108 of the cooler body 102 may have a different color from the inner section 112 of the lid 104. In some alternative embodiments, the outer shell 106 of the cooler body 102 may have a different color from the outer section 110 of the lid 104, and the liner 108 of the cooler body 102 may the same or substantially the same color as the inner section 112 of the lid 104.

In some example embodiments, the cooler 100 may include a handle 202 as more clearly shown in FIG. 2. For example, the handle may be attached to the cooler body 102 by attachment structures such as an attachment structure 204. The handle 202 may be a shoulder strap for carrying the cooler 100 on a shoulder. Alternatively, the handle 202 may be used to hand carry the cooler 100.

In some example embodiments, the liner 108 may be omitted without departing from the scope of this disclosure. In some alternative embodiments, the lid 104 may be attached to the cooler body 102 at a different side of the cooler 100. In some alternative embodiments, the cooler 100 may have a different shape than shown without departing from the scope of this disclosure. For example, the cooler body 102 may be cylindrical, and the lid 104 may be correspondingly shaped to serve as a cover for the cooler 100. As another example, the walls of the cooler body may be slanted without departing from the scope of this disclosure. As another example, the lid 104 may have a different shape while the cooler body 102 has the same shape or a similar shape as shown in FIGS. 1 and 2. In some alternative embodiments, the lid 104 may extend laterally beyond the perimeter of the cooler body 102 without departing from the scope of this disclosure. In some alternative embodiments, the cooler body 102 may extend laterally beyond the perimeter of the lid 104 without departing from the scope of this disclosure. In some alternative embodiments, the cooler 100 may include a means other than the handle 202 without departing from the scope of this disclosure.

FIG. 3 shows a front view of a cooler 300 with a two-color blow molded lid according to an embodiment. In general, the cooler 300 is similar to the cooler 100 of FIGS. 1 and 2 and may be made from the same or similar material(s) and in a similar manner. In some example embodiments, the cooler 300 includes a cooler body 302 and a lid 304. The cooler body 302 may include an outer shell 306 and a liner 308 that is positioned in the outer shell 306. A person may use the cooler 300 by placing items in a cavity of the cooler body 302.

In some example embodiments, the outer shell 306 may be made from plastic and/or another material using a method such as blow molding. The liner 308 may also be made from plastic and/or another material using a method such as injection molding. In some example embodiments, the liner 308 may be removable from the outer shell 306. In some example embodiments, the liner 308 may be a hard-sided liner. In some alternative embodiments, the liner 308 may be a soft-sided liner.

In some example embodiments, the outer shell 306 and the liner 308 may be different colors from each other. For example, the outer shell 306 may be red, and the liner 308 may be blue. As another example, the outer shell 306 may be orange, and the liner 308 may be aqua. As yet another example, the outer shell 306 may be green, and the liner 308 may be blue. As yet another example, the outer shell 306 may be gray, and the liner 308 may be purple. In general, the outer shell 306 may have one of several colors that is different from the color of the liner 308.

In some example embodiments, the lid 304 is a single-piece lid that includes an outer section 310 and an inner section 312. The inner section 312 may be visible when the lid 304 is open and may be hidden from view when the lid 104 is closed. In general, the outer section 310 of the lid 304 is visible on the outside of the cooler 310 regardless of whether lid 104 is open or closed. The lid 304 may be made from plastic and/or another material using a two-shot blow molding method in a similar manner as described above with respect to the cooler 100.

In some example embodiments, the lid 304 may be foamed. To illustrate, the inner space between the outer section 310 and the inner section 312 may be partially or fully filled with foam 332 (e.g., polyurethane foam) shown in FIG. 3 with a portion of the inner section 312 removed for illustrative purposes. Alternatively, the foam 332 may be omitted and the lid 304 may be a non-foamed lid.

In some example embodiments, the lid 304 may be rotatably attached to the cooler body 302 by attachment structures 320, 322 as can be readily understood by those of ordinary skill in the art with the benefit of this disclosure. For example, the lid 304 may be rotatably attached to the outer shell 306 using snap-fitting. In some alternative embodiments, the lid 304 may be rotatably attached to the cooler body 302 by outer means without departing from the scope of this disclosure. In some alternative embodiments, the lid 304 may not be rotatably attached to the cooler body 302. For example, the lid 304 may be a removable lid that is pressed down onto the cooler body 302 to close the cooler 300.

In some example embodiments, the lid 304 may include a compartment 314 formed at least partially in the inner section 312 and accessible from the side of the outer section 310. For example, the compartment 314 may be formed as part of the blow molding process of making the lid 302. The inner section 312 may also include an insert portion 328 and a lip portion 330. For example, the insert portion 328 may extend into the cavity of the cooler body 302 and the lip portion 330 may at least partially rest on the outer shell 106 of the cooler body 102. In some example embodiments, the inert portion 328 may come contact the liner 308 and serve to retain the lid 304 in place.

In some example embodiments, the outer section 310 of the lid 304 may have a different color from the inner section 312 of the lid 304. For example, the outer section 310 may be red, and the inner section 312 may be blue. As another example, the outer section 310 may be orange, and the inner section 312 may be aqua. As yet another example, the outer section 310 may be green, and the inner section 312 may be blue. As yet another example, the outer section 310 may be gray, and the inner section 312 may be purple. In general, the outer section 310 may have one of several colors that is different from the color of the inner section 312.

In some example embodiments, the outer shell 306 of the cooler body 302 may have the same or substantially the same color as the outer section 310 of the lid 304. For example, the outer shell 306 of the cooler body 302 and the outer section 310 of the lid 304 may be red in color. As another example, the outer shell 306 of the cooler body 302 and the outer section 310 of the lid 304 may be orange in color. As yet another example, the outer shell 306 of the cooler body 302 and the outer section 310 of the lid 304 may be blue in color. As yet another example, the outer shell 306 of the cooler body 302 and the outer section 310 of the lid 304 may be gray in color. In general, the outer shell 306 of the cooler body 302 and the outer section 310 of the lid 304 may have one of several colors. In some alternative embodiments, the outer shell 306 of the cooler body 302 and the outer section 310 of the lid 304 may have different colors from each other.

In some example embodiments, the liner 308 of the cooler body 302 may have the same or substantially the same color as the inner section 312 of the lid 304. For example, the liner 308 of the cooler body 302 and the inner section 312 of the lid 304 may be red in color. As another example, the liner 308 of the cooler body 302 and the inner section 312 of the lid 304 may be orange in color. As yet another example, the liner 308 of the cooler body 302 and the inner section 312 of the lid 304 may be blue in color. As yet another example, the liner 308 of the cooler body 302 and the inner section 312 of the lid 304 may be gray in color. In general, the liner 308 of the cooler body 302 and the inner section 312 of the lid 304 may have one of several colors. In some alternative embodiments, the liner 308 of the cooler body 302 and the inner section 312 of the lid 304 may have different colors from each other.

In some example embodiments, the outer shell 306 of the cooler body 302 may have the same or substantially the same color as the outer section 310 of the lid 304, and the liner 308 of the cooler body 302 may have the same or substantially the same color as the inner section 312 of the lid 304 but different from the color of the outer shell 306 and the outer section 310. In some alternative embodiments, the outer shell 306 of the cooler body 302 may have the same or substantially the same color as the outer section 310 of the lid 304, and the liner 308 of the cooler body 302 may have a different color from the inner section 312 of the lid 304. In some alternative embodiments, the outer shell 306 of the cooler body 302 may have a different color from the outer section 310 of the lid 304, and the liner 308 of the cooler body 302 may the same or substantially the same color as the inner section 312 of the lid 304.

In some example embodiments, the cooler 300 may include handles 316, 318 that are attached to the cooler body 102 on opposite sides. For example, the handles 316, 318 may be used to lift and carry the cooler 300 by one person or two people. Alternatively, a different means of carrying the cooler 300 may be used without departing from the scope of this disclosure. In some example embodiments, latches 324, 326 may be used to secure the lid 304 to the cooler body 302. Alternatively, a different means of securing the lid 304 to the cooler body 302 may be used without departing from the scope of this disclosure. In some example embodiments, at least a portion of each latch 324, 326 may have the same or substantially similar color as the inner section 312 of the lid 304 or another component of the cooler 300

In some example embodiments, the liner 308 may be omitted without departing from the scope of this disclosure. In some alternative embodiments, the lid 304 may be attached to the cooler body 302 at a different side of the cooler 300. In some alternative embodiments, the cooler 300 may have a different shape than shown without departing from the scope of this disclosure. In some alternative embodiments, the lid 304 may extend laterally beyond the perimeter of the cooler body 302 without departing from the scope of this disclosure. In some alternative embodiments, the cooler body 302 may extend laterally beyond the perimeter of the lid 304 without departing from the scope of this disclosure.

FIG. 4 shows a front view of a cooler 400 with a two-color blow molded lid according to an embodiment. In general, the cooler 300 is similar to the cooler 100 of FIGS. 1 and 2 and the cooler 300 of FIG. 3 and may be made from the same or similar material(s) and in a similar manner. In some example embodiments, the cooler 400 may include a cooler body 402 and a lid 404. The cooler body 402 may include an outer shell 406 and a liner similar to the liner 308 that is positioned in the outer shell 406. A person may use the cooler 400 by placing items in a cavity of the cooler body 402.

In some example embodiments, the lid 404 may correspond to the lid 304 of FIG. 3 and may be made from the same material(s) and in the same or a similar manner as described above. For example, the lid 404 may include an outer section 408 that corresponds to the outer section 410 of the lid 304. The lid 404 may also include an inner section that corresponds to the inner section 312 of the lid 304. The lid 404 may also be attached to the cooler body 402 in a similar manner as described above with respect to the lid 304 and the cooler body 302. In some example embodiments, the outer shell 406 and the liner of the cooler body 402 and the outer and inner sections of the lid 404 may have colors that correspond to the colors described above with respect to the coolers 100, 300.

In some example embodiments, the cooler 400 is different from the cooler 300 primarily in that the cooler 400 includes wheels 418, 420 and a pull-handle 416 instead of the handle 316 of the cooler 300.

In some example embodiments, the lid may include a compartment 410 that corresponds to the compartment 314 described with respect to the cooler 300. In some example embodiments, the compartment 410 may include a cover 412 formed in or attached to the outer section 408 of the lid 404. For example, the cover 412 may be made from the same material as the lid 404.

In some alternative embodiments, the cooler 400 may have a different shape than shown without departing from the scope of this disclosure. In some alternative embodiments, the lid 404 may extend laterally beyond the perimeter of the cooler body 402 without departing from the scope of this disclosure. In some alternative embodiments, the cooler body 402 may extend laterally beyond the perimeter of the lid 404 without departing from the scope of this disclosure.

FIG. 5 shows a simplified system 500 for producing the lids of the coolers 100, 300, 400 of FIGS. 1-4 according to an embodiment. In general, a double-extrusion blow molding process to produce a two-color lid involves melting a first-color material (e.g., red plastic or another polymer) and a second-color material (e.g., red plastic or another polymer), extruding the melted materials to together form a hollow tube such that the first-color material is on one side and the second-color material is on another side. Mold section may be closed around the hollow tube, where the hollow tube is inflated into the shape of the mold sections. The mold sections are opened to expose the molded two-color lid after the materials have cooled down, where the inner section of the lid is molded by one of the mold sections and the outer section of the lid is molded by the other mold section.

To illustrate, the system 500 may include channels 502, 504 for providing the two-color material. For example, a melted red plastic may be provided through the channel 502, and a melted blue plastic may be provided through the channel 504. The channels 502, 504 may provide the melted red and blue plastic materials through a container 506, where the melted red and blue plastic materials come in contact and are extruded through a port 508 as a hollow tube 518. For example, the red plastic material 10 may be on one side 510 and the blue plastic material may be on another side 512. Mold sections 514, 516, which are shown closed around portions of the plastic materials, shape the red and blue plastic materials into respective shapes of the mold sections as a result of pressurized air introduced into the hollow tube formed by the extruded red and blue plastic materials. For example, the mold section 514 may form the red plastic portion of the extruded plastic materials in the desired shape for the outer section of a lid (e.g., the lid 104, 304, 404), and the mold section 516 may form the blue plastic portion of the extruded plastic materials in the desired shape for the inner section of the lid. After the blow molded lid is cooled, the molded sections 514, 526 may be opened, and the molded lid may be removed. A lid, such as the lids 104, 304, 404, may be formed as a single-piece lid using an extrusion blow molding system, such as the system 500, where the inner surface of the lid has a desired color that is the same or different from the color of the outer section of the lid and/or the outer shell or the liner of a cooler body.

In some alternative embodiments, the blow molding system that is different from the system 500 may be used to produce a lid such as the lids 104, 304, 404. In some alternative embodiments, the system 500 may include other components such as components for introducing water for cooling purposes without departing from the scope of this disclosure.

The foregoing description has been directed to certain embodiments of the present disclosure. It will be apparent, however, that other variations and modifications may be made to the described embodiments, with the attainment of some or all of their advantages. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A cooler with a two-color lid, the cooler comprising:
a cooler body; and
a lid designed to cover a cavity of the cooler body, wherein the lid comprises an outer section and an inner section, wherein the lid is a blow-molded lid, and wherein a color of the outer section is different from a color of the inner section.

2. The cooler of claim 1, wherein the lid is a single-piece lid.

3. The cooler of claim 1, wherein the inner section of the lid is hidden from view when the lid is closed.

4. The cooler of claim 1, wherein the cooler body includes an outer shell and a liner, wherein the liner is positioned in a cavity of the outer shell.

5. The cooler of claim 4, wherein a color of the liner is same as the color of the inner section of the lid.

6. The cooler of claim 5, wherein a color of the outer shell is same as the color of the outer section of the lid.

7. The cooler of claim 4, wherein the outer shell is a blow-molded shell and wherein the liner is an injection-molded liner.

8. The cooler of claim 1, wherein the lid is rotatably attached to the cooler body.

9. The cooler of claim 1, further comprising a handle attached to the cooler body.

10. The cooler of claim 9, further comprising one or more wheels attached to the cooler body on an opposite end of the outer shell from a location the handle.

11. The cooler of claim 1, wherein the lid is made from plastic.

12. The cooler of claim 11, wherein the outer shell is made from plastic.

13. The cooler of claim 1, wherein a space between the outer section and the inner section is at least partially filled with foam.

14. A method of manufacturing a cooler with a two-color lid, the method comprising:
blow molding a first material into an outer shell of a cooler body; and
blow molding a first color material and a second color material into a lid having an inner section and an outer section, wherein the first color material and the second color material are extruded together, wherein the first color material is blow molded into the inner section, wherein the second color material is blow molded into the outer section, and wherein the first color material is different in color from the second color material.

15. The method of claim 14, wherein the first material is plastic.

16. The method of claim 14, wherein the first color material and the second color material are each plastic.

17. The method of claim 14, further comprising injection molding a second material into a liner and inserting the liner in a cavity of the outer shell.

18. The method of claim 17, wherein a color of the inner section of the lid is same as a color of the liner.

19. The method of claim 17, wherein a color of the outer section of the lid is same as a color of the outer shell.

20. The method of claim 14, further comprising attaching the lid rotatably to the outer shell.

21. The method of claim 14, further comprising attaching a handle to the outer shell.
